(19) United States
(12) Patent Application Publication
(10) Pub. No.: US 2020/0109069 A1
(43) Pub. Date: Apr. 9, 2020

(54) Apparatus for Treating Spent Radioactive Ion Exchange Resins and Method for Treating Spent Radioactive Ion Exchange Resin

(71) Applicant: Korea Atomic Energy Research Institute, Daejeon (KR)

(72) Inventors: Hee Chul Yang, Daejeon (KR); Hyung Ju Kim, Gyeonggi-do (KR); Hee Chul Eun, Daejeon (KR); Keun Young Lee, Sejong-si (KR); Bum Kyoung Seo, Daejeon (KR)

(73) Assignee: Korea Atomic Energy Research Institute, Daejeon (KR)

(21) Appl. No.: 16/550,978

(22) Filed: Aug. 26, 2019

(30) Foreign Application Priority Data
Aug. 31, 2018 (KR) 10-2018-0103948

(51) Int. Cl. C02F 1/42; G21F 9/12; G21F 9/08

(52) U.S. Cl. CPC C02F 1/42; C02F 2101/006; G21F 9/08; G21F 9/12

(57) ABSTRACT

The present invention relates to an apparatus for treating a spent ion exchange resin, the apparatus including: a graphite reactor for receiving a spent ion exchange resin including a radionuclide-containing ion exchange group therein; a graphite heater for heating the spent ion exchange resin; an inert gas injection tube for injecting an inert gas into the graphite reactor for drying and carbonizing the spent ion exchange resin; and a halogenation gas injection tube for injecting a halogen-containing gas or a halogenation compound gas into the graphite reactor for halogenation of a compound derived from the radionuclide-containing ion exchange group, and to a method for treating a spent ion exchange resin, the method including steps of (A) drying a spent ion exchange resin including a radionuclide-containing ion exchange group; (B) producing a compound derived from the radionuclide-containing ion exchange group by separating the radionuclide-containing ion exchange group from the dried spent ion exchange resin; (C) carbonizing the spent ion exchange resin from which the radionuclide-containing ion exchange group is separated; and (D) converting a compound derived from the radionuclide-containing ion exchange group into a radionuclide-containing halide, in which steps (A) to (D) are performed in the same graphite reactor.

### CROSS-REFERENCE TO RELATED APPLICATION

This application claims priority to and the benefit of Korean Patent Application No. 10-2018-0103948, filed on Aug. 31, 2018, the disclosure of which is incorporated herein by reference in its entirety.

### BACKGROUND

### 1. Field of the Invention

The present invention relates to an apparatus and method for treating a spent radioactive ion exchange resin including a radionuclide-containing ion exchange group, and more particularly, to a technique for separating, removing, or reducing a radionuclide from a spent ion exchange resin including a radionuclide-containing ion exchange group by a stepwise heat treatment of the spent ion exchange resin in the same graphite reactor.

### 2. Discussion of Related Art

An ion exchange resin used in the treatment of radioactive liquid waste is an ion exchange resin through which an ion exchange group is bonded to a polymer having a micro 3-dimensional structure, consists of a polymer material that exchanges/purifies ionic substances dissolved in a polar or non-polar solution, and serves to clean up waste liquid by allowing movable ions of the ion exchange resin to be substituted with other ions in the solution (waste liquid). Such ion exchange resins are used particularly in the nuclear industry to purify cleaning water or cooling water used in nuclear power plants.

When the radioactive waste liquid is purified/decontaminated using the ion exchange resin as described above, the used ion exchange resin is gradually changed to a spent ion exchange resin. In the case of the spent ion exchange resin generated in this way, since a functional group present on the surface of an ion exchange resin manufactured of a high-molecular weight polymer having excellent mechanical strength or chemical resistance is remaining in an ion exchange form which is substituted with a radionuclide, it is very difficult to separate and extract the radionuclides attached to the ion exchange resin, so that the spent ion exchange resin has been recognized as one of the combustible radioactive wastes generated from nuclear power plants, which are the most difficult to be treated.

A total amount of the spent ion exchange resin generated from nuclear power plants as described above should be stabilized, put into a barrel, and sent to a radioactive waste disposal site when radioactivity is detected even in a trace amount. Such radioactive waste cannot be classified and treated as general waste unless its radioactivity is reduced to a level in which self-disposal is possible, and the radioactivity does not disappear completely even though the contaminated spent ion exchange resin is stored for a long period of time, so that the development of a technique for separating/extracting and decontaminating radionuclides from the spent ion exchange resin contaminated as described above so as to be self-disposed is very important from the viewpoint of reducing radioactive waste (spent ion exchange resin) and cutting disposal costs.

Among the treatment methods for treating such a spent ion exchange resin in the related art, Korean Patent Application Laid-Open No. 10-2008-0087360 discloses a radioactive spent ion exchange resin dehydrator as a method that may increase treatment efficiency by increasing the amount of radioactive spent ion exchange resin treated. Specifically, it discloses a dehydrator for a radioactive spent ion exchange resin, including a porous vessel receiving a radioactive spent ion exchange resin and having pores at the bottom surface thereof, an intermediate vessel receiving the porous vessel and protecting the porous vessel, and a blocking vessel blocking radioactivity emitted from the radioactive spent ion exchange resin.

Meanwhile, as other methods for treating a spent ion exchange resin in the related art, combustible organic components are treated by thermal decomposition or oxidation for gasification, and inorganic components including residual radionuclides, that is, ash (incinerated material) may be stabilized and treated by a method such as vitrification. Korean Registered Patent No. 10-0498881 discloses an apparatus and process for incinerating and melting radioactive waste, and specifically discloses an apparatus and process for treating off-gas produced during the vitrification process by incinerating and melting combustible medium and low-level radioactive waste. However, the spent ion exchange resins generated from nuclear power-related facilities consist mostly of organic components, that is, combustible components, so that the volume may be effectively reduced by incineration or thermal decomposition as described above, but in such a process, a problem in that the radionuclide fixed in the spent ion exchange resin may be discharged together with the exhaust gas occurs. Further, since all organic components are gasified, the apparatus and process have a problem in that a large amount of a global warming gas CO₂ is emitted, and sulfur dioxide gas and unburned hydrocarbons, or toxic gases such as dioxins and nitrogen oxides (NOₓ), a high-temperature volatile radionuclide radioactive cesium (Cs-137, Cs-134), and the like are gasified and emitted.

Korean Registered Patent No. 10-0858510 discloses a method for separating spent ion exchange resins generated from nuclear power plants into spent cationic resins and spent anionic resins using a specific gravity difference separator, in which the spent cationic resin is treated by a supercritical water oxidation technique, but there is a problem in that the treatment process is complicated and sulfuric acid waste water is generated after the treatment.

In addition, the existing technique for first drying spent ion exchange resins in a dryer, carbonizing the dried spent ion exchange resins in a reactor, putting and heating radionuclides converted into sulfur oxides and other inorganic components in a furnace at high temperature, and converting the radionuclides and the inorganic components into chloride forms, volatilizing them, and separating them is divided into a plurality of systems, such as a dryer, a carbonization reactor, and a chlorination reactor, respectively, and each apparatus has a separate exhaust gas treatment apparatus, so that there are problems in that the entire process is complicated and installation investment costs and operation costs for the process are not efficient.

Therefore, there is an urgent need for developing an apparatus and method for treating a spent ion exchange resin, which solves the emission problem of sulfur oxides, carbon dioxide, and high-temperature volatile radionuclides such as radioactive cesium generated during the treatment of the spent ion exchange resin, and simultaneously simplifies the configuration and process of the apparatus, and furthermore, may reduce installation and operation costs.

### Prior Art Document

(Patent Document 1) Korean Patent Application Laid-Open No. 10-2008-0087360

(Patent Document 2) Korean Registered Patent No. 10-0498881

(Patent Document 3) Korean Registered Patent No. 10-0858510

### SUMMARY OF THE INVENTION

The present invention has been made in an effort to solve the problems as described above, and relates to an apparatus and method for simplifying the configuration of an apparatus for volatilizing and separating/recovering only radionuclides without gasifying carbon which is a main component of a spent ion exchange resin by drying and carbonizing a spent ion exchange resin including a radionuclide-containing ion exchange group and halogenating a compound derived from a radionuclide-containing ion exchange group in one same reactor, for cutting installation costs and operation costs of a treatment process while obtaining a maximum reduction effect by preventing a problem of generation of an exhaust gas including SO₂ and a problem of generation of a global warming gas CO₂ and volatilizing and separating/recovering radionuclides, and for reducing the radiation exposure of workers during the process of transporting a spent ion exchange resin from which radionuclides are not removed.

An embodiment of the present invention provides an apparatus for treating a spent ion exchange resin, the apparatus including: a graphite reactor for receiving a spent ion exchange resin including a radionuclide-containing ion exchange group therein; a graphite heater for heating the spent ion exchange resin; an inert gas injection tube for injecting an inert gas into the graphite reactor for drying and carbonizing the spent ion exchange resin; and a halogenation gas injection tube for injecting a halogen-containing gas or a halogenation compound gas into the graphite reactor for halogenation of a compound derived from the radionuclide-containing ion exchange group.

Further, another embodiment of the present invention provides a method for treating a spent ion exchange resin, the method including steps of (A) drying a spent ion exchange resin including a radionuclide-containing ion exchange group; (B) producing a compound derived from the radionuclide-containing ion exchange group by separating the radionuclide-containing ion exchange group from the dried spent ion exchange resin; (C) carbonizing the spent ion exchange resin from which the radionuclide-containing ion exchange group is separated; and (D) converting a compound derived from the radionuclide-containing ion exchange group into a radionuclide-containing halide, in which steps (A) to (D) are performed in the same graphite reactor.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a view schematically illustrating an apparatus for treating a spent ion exchange resin according to an embodiment of the present invention;

FIG. 2 is a view schematically illustrating a graphite reactor included in the apparatus for treating a spent ion exchange resin according to an embodiment of the present invention;

FIG. 3 is a view schematically illustrating a process in which a radionuclide-containing ion exchange group is separated from a spent ion exchange resin;

FIG. 4 is a graph illustrating the form of a compound which may be formed depending on the temperature and oxygen partial pressure in an S—Cs—O system;

FIG. 5 is a graph illustrating the form of a compound which may be formed depending on the temperature and oxygen partial pressure in an S—Cs—O system;

FIG. 6 is a graph illustrating the temperature and thermodynamic equilibrium concentration at which Ba, Cs, and Co are converted into chlorides which are highly volatile at high temperature, gasified, and separated from carbides when Ba, Cs, and Co which are nuclide metals present in the form of sulfur oxides in a carbonized spent ion exchange resin according to an embodiment of the present invention are mixed with Cl₂ (g), HCl (g), or CCl₄;

FIG. 7 is a graph illustrating the temperature and thermodynamic equilibrium concentration at which Cs, Co, Mn, Fe, and Ni are converted into chlorides which are highly volatile at high temperature, gasified, and separated from carbides when Cs, Co, Mn, Fe, and Ni which are nuclide metals present in the form of sulfur oxides in a carbonized spent ion exchange resin according to an embodiment of the present invention are mixed with Cl₂ (g), HCl (g), or CCl₄;

FIG. 8 is a graph illustrating the temperature and thermodynamic equilibrium concentration at which Ba, Cs, and Sr are converted into fluorides which are highly volatile at high temperature, gasified, and separated from carbides when Ba, Cs, and Sr which are nuclide metals present in the form of sulfur oxides in a carbonized spent ion exchange resin according to an embodiment of the present invention are mixed with F₂ (g), HF (g), or SF₆.

FIG. 9 is a graph illustrating the temperature and thermodynamic equilibrium concentration at which Co, Fe, Mn, and Ni are converted into fluorides which are highly volatile at high temperature, gasified, and separated from carbides when Co, Fe, Mn, and Ni which are nuclide metals present in the form of sulfur oxides in a carbonized spent ion exchange resin according to an embodiment of the present invention are mixed with F₂ (g), HF (g), or SF₆.

FIG. 10 is a graph illustrating the temperature and thermodynamic equilibrium concentration at which Co, Mn, Fe, and Ni are converted into chlorides or fluorides which are highly volatile at high temperature, gasified, and separated from carbides when Co, Mn, Fe, and Ni which are nuclide metals present in the form of sulfur oxides in a carbonized spent ion exchange resin according to an embodiment of the present invention are mixed with a CCl₂F₂ gas; and

FIG. 11 is a graph illustrating the temperature and thermodynamic equilibrium concentration at which Ba, Cs, and Sr are converted into chlorides or fluorides which are highly volatile at high temperature, gasified, and separated from carbides when Ba, Cs, and Sr which are nuclide metals present in the form of sulfur oxides in a carbonized spent ion exchange resin according to an embodiment of the present invention are mixed with a CCl₂F₂ gas.

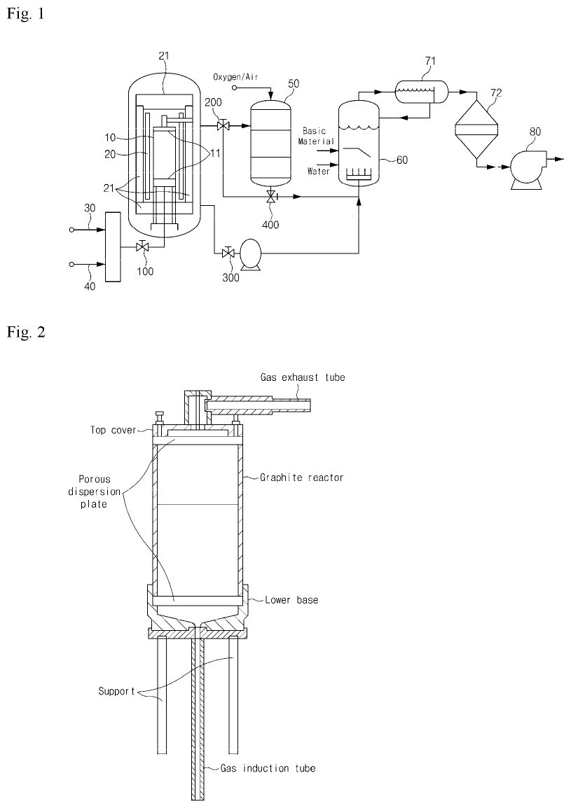

### DETAILED DESCRIPTION OF EXEMPLARY EMBODIMENTS

Hereinafter, the present invention will be described in detail.

1. Apparatus for Treating Spent Ion Exchange Resin

The present invention provides an apparatus for treating a spent ion exchange resin.

The apparatus for treating a spent ion exchange resin of the present invention includes: a graphite reactor for receiving a spent ion exchange resin including a radionuclide-containing ion exchange group therein; a graphite heater for heating the spent ion exchange resin; an inert gas injection tube for injecting an inert gas into the graphite reactor for drying and carbonizing the spent ion exchange resin; and a halogenation gas injection tube for injecting a halogen-containing gas or a halogenation compound gas into the graphite reactor for halogenation of a compound derived from the radionuclide-containing ion exchange group.

Hereinafter, the apparatus for treating a spent ion exchange resin of the present invention will be described in detail with reference to drawings.

The graphite reactor 10 is for stepwisely performing the drying of the spent ion exchange resin, the separation of the radionuclide-containing ion exchange group, the carbonization of the spent ion exchange resin, and the halogenation of the compound derived from the radionuclide-containing ion exchange group, and all the processes as described above are performed in the same graphite reactor 10.

In particular, graphite which is a material for the graphite reactor 10 is a conductor which is not melted at 3,000° C. or less, and has excellent thermal conductivity in contrast to most non-metallic components or composites. Further, graphite also has an advantage in that dimensional (volume) stability is excellent due to a small range of thermal expansion.

A porous dispersion plate 11 may be included in each of an upper part and a lower part in the graphite reactor 10. The porous dispersion plate 11 may be a graphite plate having fine pores through which carbide particles of the spent ion exchange resin having a particle size of about 100 to 400 microns, which are formed by carbonization after the spent ion exchange resin is dried, do not fall out. By providing the porous dispersion plate 11 in the graphite reactor 10 as described above, a fixed bed reaction or fluidized bed reaction may be performed in the graphite reactor 10.

By mounting the porous dispersion plate 11 (graphite plate) having pores as described above, spent ion exchange resin particles which are fluidized and floated may be prevented from being discharged out of the graphite reactor 10.

In the graphite reactor 10, the spent ion exchange resin is sufficiently filled between the porous dispersion plates 11 located in each of the upper part and the lower part of the graphite reactor 10, and the drying or carbonization of the spent ion exchange resin may first proceed in the form of a fixed bed reaction, and the particle size of the spent ion exchange resin is reduced as the drying or carbonization proceeds as described above, so that the halogenation process after carbonization may be easily performed by a fluidized reaction.

The graphite heater 20 is a heater made of graphite or carbon fiber, and serves to transmit thermal wavelength to the spent ion exchange resin by irradiating the graphite heater with short wavelength rays that are harmless to the human body without heating the air during heating. The graphite heater as described above has a good thermal efficiency, and thus has an effect of reducing energy by about 30% at the same calorific value when compared with far infrared heaters and halogen heaters. Further, the graphite heater has an excellent calorific value, so that there is an advantage in that the spent ion exchange resin can be heated very quickly.

The graphite heater 20 may be disposed outside the graphite reactor 10, and for example, when the graphite reactor 10 is a cylindrical reactor, the graphite heater may have a cylindrical shape surrounding the graphite reactor 10, and the position disposed around the graphite reactor 10 is not limited as long as the spent ion exchange resin in the graphite reactor 10 is sufficiently heated.

The graphite heater 20 may be set so as to adjust the temperature inside the graphite reactor 10, such that the graphite heater 20 may perform steps of drying the spent ion exchange resin, separating the radionuclide-containing ion exchange group, carbonizing the spent ion exchange resin, and halogenating a compound derived from the radionuclide-containing ion exchange group, and specifically, the temperature of the graphite reactor 10 may be adjusted to a temperature range of 100° C. to 3,000° C.

It is possible to further include a temperature adjusting member for adjusting the temperature inside the graphite reactor 10 in accordance with the drying of the spent ion exchange resin, the separation of the radionuclide-containing ion exchange group, the carbonization of the spent ion exchange resin, and the halogenation of the compound derived from the radionuclide-containing ion exchange group.

Further, the outside of the graphite reactor 10 may be surrounded by a graphite insulating material 21. That is, the graphite insulating material 21 may be disposed in the form of surrounding the graphite heater 20. The heat loss released to the outside of a system in a high-temperature reaction occurring in the graphite reactor 10 is reduced by the graphite insulating material 21, so that the drying, carbonization, and halogenation reaction of the spent ion exchange resin may be efficiently performed in the same graphite reactor 10.

The radionuclide-containing ion exchange group may further contain sulfur atoms.

The inert gas injection tube 30 may be for converting the radionuclide-containing ion exchange group separated from the spent ion exchange resin into a compound derived from a radionuclide-containing ion exchange group.

The compound derived from the radionuclide-containing ion exchange group may be at least one of radionuclide-containing sulfides and sulfur oxides.

Specifically, the radionuclide-containing ion exchange group separated from the spent ion exchange resin may be converted into at least one of a radionuclide-containing sulfide and a radionuclide-containing sulfur oxide via at least one of a radionuclide-containing oxide and a radionuclide-containing hydroxide.

The inert gas injection tube 30 may be formed such that an inert gas is injected into the graphite reactor 10 in the process of drying the spent ion exchange resin including the radionuclide-containing ion exchange group or carbonizing the spent ion exchange resin from which the radionuclide-containing ion exchange group is separated, or the process of separating a radionuclide-containing ion exchange group from the spent ion exchange resin including the radionuclide-containing ion exchange group and converting the radionuclide-containing ion exchange group into at least one of a radionuclide-containing sulfide and a radionuclide-containing sulfur oxide.

The inert gas injection tube 30 may be installed in communication with the graphite reactor 10, and the apparatus for treating a spent ion exchange resin may further include a first valve 100 for adjusting the injection of an inert gas from the inert gas injection tube 30 into the graphite reactor 10 in the inert gas injection tube 30.

In this case, the inert gas may be argon or nitrogen.

The halogenation gas injection tube 40 may be for converting the radionuclide-containing sulfide or sulfur oxide into a radionuclide-containing halide.

The halogenation gas injection tube 40 may be installed in communication with the graphite reactor 10, and the apparatus for treating a spent ion exchange resin may further include the first valve 100 in order to adjust the injection of a halogen-containing gas or a halogenation compound gas from the halogenation gas injection tube 40 into the graphite reactor 10.

In this case, the halogen-containing gas is at least one selected from F₂, Cl₂, Br₂, HCl, and HF, and the halogenation compound gas is a gas that generates a halogen gas at high temperature, and may be at least one selected from NF₃, CFCs, SF₆, and CCl₄.

The inert gas injection tube 30 and the halogenation gas injection tube 40 may be provided so as to select an injection gas (an inert gas or a halogenation gas) as the first valve is adjusted in the same gas injection tube, and may be installed independently in communication with the graphite reactor 10, and thus provided so as to select an injection gas as each first valve is adjusted.

The apparatus for treating a spent ion exchange resin may further include a cleaning apparatus 60 in order to clean a volatile radionuclide gas (tritium (³H), radioactive carbon (¹⁴C), and the like), water vapor, or an acidic gas (CO₂, SO₂, SO₃, and the like) generated by heating the spent ion exchange resin. The cleaning apparatus 60 is in communication with the graphite reactor 10, and the apparatus for treating a spent ion exchange resin may further include a third valve 300, such that gases in the graphite reactor 10 and the cleaning apparatus 60 are not mixed.

A basic material may be introduced such that an acidic gas may be neutralized in the cleaning apparatus 60, and water may be included such that the volatile radionuclide gas or water vapor may be condensed. The basic material may be NaOH, KOH, and the like, but is not limited thereto.

The apparatus for treating a spent ion exchange resin may further include a post-combustion apparatus 50 for treating an exhaust gas generated by heating the spent ion exchange resin. The post-combustion apparatus 50 may be installed in communication with the graphite reactor 10 and the cleaning apparatus 60. In this case, a second valve may be further included such that gases in the post-combustion apparatus 50 and the graphite reactor 10 are not mixed, and a fourth valve may be further included such that gases in the post-combustion apparatus 50 and the cleaning apparatus 60 are not mixed.

In the process of separating the radionuclide-containing ion exchange group from the spent ion exchange resin and converting the same into a radionuclide-containing sulfide or sulfur oxide, organic components in the spent ion exchange resin are thermally decomposed, so that an exhaust gas may be generated, and in this case, examples of the exhaust gas to be generated include benzene, toluene, ethylbenzene, styrene, and the like which are organic gases, along with sulfur dioxide gas (SO₂).

The post-combustion apparatus 50 serves to thermally decompose (or completely oxidize) the above-described exhaust gas into CO₂ or H₂O.

The post-combustion apparatus 50 may be a high-temperature electric furnace, a post-combustion furnace including a gas burner, a plasma combustion furnace, a catalytic combustion furnace, and the like, and any form may be used without limitation as long as the post-combustion apparatus 50 is an apparatus for completely combusting the organic gases.

In addition, the apparatus for treating a spent ion exchange resin may further include a filtration apparatus for condensing/fixing/collecting a radionuclide which has not been collected/treated from the post-combustion apparatus 50 or the cleaning apparatus 60.

The filtration apparatus may include a condenser 71 for condensing a radionuclide which has not been cleaned in the cleaning apparatus 60, and an air filter 72 for filtering the same. In addition, the gas from which the radionuclide has been removed through the air filter 72 may be emitted/discharged to the outside through an exhaust apparatus 80.

Hereinafter, a process of operating the apparatus for treating a spent ion exchange resin will be described in detail.

First, in order to dry a spent ion exchange resin including a radionuclide-containing ion exchange group, after the spent ion exchange resin is introduced into a graphite reactor 10, only a third valve 300 is opened while a first valve 100, a second valve 200, and a fourth valve 400 are closed, the graphite reactor 10 is evacuated while being heated to 100° C. to 150° C. to remove water vapor, a volatile radionuclide gas (tritium (³H), radioactive carbon (¹⁴C), and the like), or an acidic gas (CO₂).

The water vapor, volatile radionuclide gas, or acidic gas separated as described above are collected and condensed in a cleaning apparatus 60. In this case, in order to shorten the drying time, a heated inert gas may also be supplied through the inert gas injection tube 30 by opening the first valve 100, and a fluidized bed reaction may also be performed using a porous dispersion plate 11 inside the graphite reactor 10.

Next, by injecting an inert gas (nitrogen or argon) into the lower part of the graphite reactor 10 filled with the dried spent ion exchange resin in a state where the first valve 100 and the second valve 200 are opened and the third valve 300 is closed, the graphite heater 20 is set such that the temperature of the graphite reactor 10 is 150° C. to 400° C.

In this case, the radionuclide-containing ion exchange group is separated from the dried spent ion exchange resin, so that the dried spent ion exchange resin is separated into a spent ion exchange resin which does not include the radionuclide and a radionuclide-containing ion exchange group.

The radionuclide-containing ion exchange group may further contain sulfur atoms.

The spent ion exchange resin may include a styrene divinylbenzene polymer, a sulfonic acid group (SO₃H⁺) and a functional group (SO₃M⁺) including a radionuclide cation (M⁺), and in this case, the ion exchange group may be a sulfonic acid group (SO₃H⁺) or SO₃M⁺ which is a functional group including a radionuclide cation (M⁺).

When a radionuclide-containing ion exchange group is separated from the spent ion exchange resin, the radionuclide-containing ion exchange group is converted into a compound derived from a radionuclide-containing ion exchange group, and in this case, the compound derived from the radionuclide-containing ion exchange group may be at least one of a radionuclide-containing sulfide and a radionuclide-containing sulfur oxide.

The radionuclide-containing sulfide and the radionuclide-containing sulfur oxide may be produced after the radionuclide-containing ion exchange group is separated from the spent ion exchange resin, and then becomes at least one of a radionuclide-containing oxide and a radionuclide-containing hydroxide.

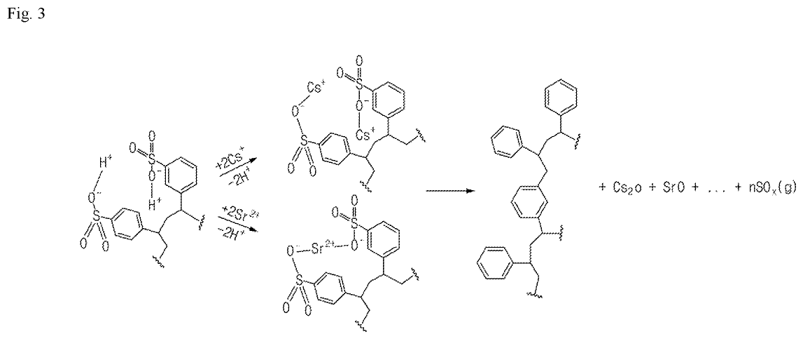

Specifically, as illustrated in FIG. 3, when the radionuclide-containing ion exchange group is separated from the spent ion exchange resin, an exhaust gas including a styrene divinylbenzene copolymer, a radionuclide-containing oxide or hydroxide, and sulfur dioxide gas (SO₂) is generated, and thus may be present in the graphite reactor 10. In this case, when the generated sulfur dioxide gas (SO2) is allowed to remain sufficiently in the graphite reactor 10, the radionuclide-containing oxide or radionuclide-containing hydroxide may be converted into a sulfide or sulfur oxide including a radionuclide.

Subsequently, by adjusting the graphite heater 20 such that the temperature of the graphite reactor 10 becomes 400° C. to 550° C., the radionuclide-containing ion exchange group separated from a spent ion exchange resin may be converted into a compound derived from a radionuclide-containing ion exchange group after becoming the radionuclide-containing oxide or radionuclide-containing hydroxide. When the sulfur dioxide gas (SO₂) generated during the previous separation of the ion exchange group is present even in a trace amount in the graphite reactor 10, the radionuclide-containing oxide or radionuclide-containing hydroxide may be converted into a compound derived from the radionuclide-containing ion exchange group.

In particular, the radionuclide-containing oxide or radionuclide-containing hydroxide is volatile, but the radionuclide-containing sulfide or radionuclide-containing sulfur oxide is non-volatile, and thus remains in the graphite reactor 10.

Further, in this step, an organic component present in the spent ion exchange resin from which the radionuclide-containing ion exchange group is separated may be thermally decomposed, and as a result, an exhaust gas such as benzene, toluene, ethylbenzene, and styrene, which are organic gases, may be generated along with sulfur dioxide gas (SO₂).

For the treatment of such an exhaust gas, the organic gas may be completely combusted and thermally decomposed into CO₂ or H₂O by the post-combustion apparatus 50, and for this purpose, oxygen or air may be additionally injected into the post-combustion apparatus 50.

A gas including sulfur dioxide gas (SO₂), CO₂, and H₂O discharged from the post-combustion apparatus 50 may be completely cleaned/collected through the cleaning apparatus 60.

In order to treat a residual organic material remaining in the spent ion exchange resin from which the radionuclide-containing ion exchange group is separated (the radionuclide is removed), the graphite heater 20 may be adjusted, such that the temperature of the graphite reactor 10 becomes 550° C. to 700° C. Under the conditions as described above, residual organic materials remain in the spent ion exchange resin from which the radionuclide is removed, and among them, oxygen, hydrogen, and nitrogen components are vaporized, and then cleaned and collected by the cleaning apparatus 60, and carbon components are carbonized into carbides, and then remain in the graphite reactor 10.

In particular, the components to be vaporized (oxygen, hydrogen, and nitrogen components) do not include a radionuclide or sulfur dioxide gas (SO₂), so that there is an advantage in that it is possible to exclude a problem in that a radionuclide is deposited in an exhaust gas process, a problem in that a radionuclide is discharged into the atmosphere along with an exhaust gas, and a problem in that an exhaust gas including sulfur dioxide gas (SO₂) is generated, which occur in the related art.

Next, the radionuclide-containing sulfide or radionuclide-containing sulfur oxide is converted into a radionuclide-containing halide by opening the first valve 100 to inject a halogen-containing gas or a halogenation compound gas, and adjusting the graphite heater 20 such that the temperature of the graphite reactor 10 becomes 800° C. to 900° C.

In this case, when the radionuclide-containing sulfide or radionuclide-containing sulfur oxide is converted into a radionuclide-containing halide by injecting a halogen-containing gas, an unreacted halogen-containing gas may be introduced and collected directly into the cleaning apparatus 60 without passing through the post-combustion apparatus 50 by adjusting the second valve 200 and the fourth valve 400, and when the radionuclide-containing sulfide or radionuclide-containing sulfur oxide is converted into a radionuclide-containing halide by injecting a halogenation compound gas, an unreacted halogenation compound gas needs to be thermally decomposed by adjusting the second valve 200 and the fourth valve 400, and then collected in the cleaning apparatus 60.

In this case, a halogen-containing gas or a halogenation compound gas may be introduced into the lower part of the graphite reactor 10 through the halogenation gas injection tube 40. In this case, the halogen-containing gas is at least one selected from F₂, Cl₂, Br₂, HCl, and HF, and the halogenation compound gas may be at least one selected from NF₃, CFCs, SF₆, and CCl₄.

The at least one selected from NF₃, CFCs, SF₆, and CCl₄ may be decomposed at high temperature to generate chlorine gas (Cl₂) or fluorine gas (F₂), and the radionuclide-containing sulfide or sulfur oxide may react with a halogen gas to form a radionuclide-containing halide.

Thereafter, the temperature of the graphite reactor may be adjusted to 1,400° C. to 3,000° C. in order to separate the radionuclide by vacuum-evaporating or condensing the radionuclide-containing halide.

Furthermore, the radionuclide which has not been cleaned and collected in the cleaning apparatus 60 may be completely collected through a filtration apparatus including a condenser 71 and an air filter 72, so that the gas discharged to the outside (in air) through an exhaust apparatus 80 may not include the radionuclide or may minimize the content thereof.

2. Method for Treating Spent Ion Exchange Rresin

The present invention provides a method for treating a spent ion exchange resin.

The method for treating a spent ion exchange resin of the present invention includes steps of (A) drying a spent ion exchange resin including a radionuclide-containing ion exchange group; (B) producing a compound derived from the radionuclide-containing ion exchange group by separating the radionuclide-containing ion exchange group from the dried spent ion exchange resin; (C) carbonizing the spent ion exchange resin from which the ion exchange group is separated; and (D) converting a compound derived from the radionuclide-containing ion exchange group into a radionuclide-containing halide, in which steps (A) to (D) may be performed in the same graphite reactor.

Hereinafter, the method for treating a spent ion exchange resin according to the present invention will be described in detail for each step.

Step (A) is a step of drying a spent ion exchange resin including the radionuclide-containing ion exchange group through heating, and a step for removing water vapor, a volatile radionuclide gas (tritium (³H), radioactive carbon (¹⁴C), and the like), or an acidic gas (CO₂) contained from the spent ion exchange resin. Further, it is also possible to concentrate dissolved solids and suspended solids contained in the spent ion exchange resin.

The spent ion exchange resin including the radionuclide-containing ion exchange group may be an ion exchange resin that has been used for a long time in the process of purifying radioactive waste liquid. That is, examples of a spent ion exchange resin including a radionuclide that has been used and produced in the process of purifying radioactive waste liquid include a condensate polishing plant (CPP) spent ion exchange resin generated during the process of purifying condensate of a turbine condensate water system with a relatively low radioactivity level, a blowdown (BD) spent ion exchange resin generated during the purification of a steam generator blowdown system, and the like, and a spent ion exchange resin generated during the process of purifying liquid waste in a liquid radwaste system (LRS) with a slightly high radioactivity level, and the like. The radionuclide may be Cs, Sr, Mn, Fe, Ba, Ni, or Co.

The spent ion exchange resin may be an ion exchange resin which includes a functional group which may be ionized by chemically binding the ion exchange resin to a polymer, and is produced by substituting ions included in the functional group with the radionuclide in waste liquid. For example, the ion exchange resin may include a functional group including a sulfonic acid group (SO₃H⁺) in a styrene divinylbenzene copolymer, and the cations present in the ion exchange resin may be substituted with a radionuclide present in waste liquid to form a spent ion exchange resin including a radionuclide.

For example, the ion exchange resin may include cations such as hydrogen ions in order to remove a radionuclide including radioactive cesium (¹³⁷Cs) in waste liquid, and in this case, if one radioactive cesium (¹³⁷Cs) ion having a charge of 2+ is present from the surrounding solution, the one radioactive cesium ion may also be substituted with two hydrogen ions having a charge of 1+ to become a spent ion exchange resin.

The step of drying a spent ion exchange resin including the radionuclide-containing ion exchange group in step (A) may be performed within a temperature range of 100° C. to 150° C. When the temperature for performing the drying of the spent ion exchange resin in step (A) is less than 100° C., the vaporization of moisture may not occur, and further, when the temperature is more than 150° C., the separation of the ion exchange group occurs, so that a problem in that not only moisture but also a gas including sulfur dioxide gas (SO₂) are simultaneously discharged may occur.

In order to dry the spent ion exchange resin in step (A), the spent ion exchange resin including a radionuclide-containing ion exchange group is introduced into the graphite reactor, in which the graphite reactor is provided with a porous dispersion plate in each of the upper part and the lower part therein, so that step (A) may also be performed as a fixed bed reaction by sufficiently filling the graphite reactor with the spent ion exchange resin, and step (A) may also be performed as a fluidized bed rector by filling the graphite reactor with a suitable amount of spent ion exchange resin. That is, steps (A) to (D) may be performed as a fixed bed reaction or a fluidized bed reaction in the graphite reactor.

Further, even when performing a fixed bed reaction by sufficiently filling the spent ion exchange resin between the porous dispersion plates as described above, since the size (volume) of the spent ion exchange resin is decreased after the drying and carbonization steps of the spent ion exchange resin, a halogenation decontamination step may be carried out by conversion into a fluidized bed reaction.

The porous dispersion plate may be a graphite plate having fine pores through which carbide particles of the spent ion exchange resin having a particle size of about 100 to 400 microns, which are formed by carbonization after the spent ion exchange resin is dried, do not fall out.

The method for treating a spent ion exchange resin may further include steps of cleaning and collecting, in a cleaning apparatus, water vapor, a volatile radionuclide gas (tritium (³H), radioactive carbon (¹⁴C), and the like), or an acidic gas (CO₂) separated from the spent ion exchange resin in step (A).

In this case, step (A) may also be performed while injecting an inert gas in the graphite reactor in order to shorten the drying time in step (A). Specifically, step (A) may also be performed while supplying heated nitrogen or other inert gases (argon, and the like).

Step (B) is a step which produces a compound derived from a radionuclide-containing ion exchange group by separating the radionuclide-containing ion exchange group from the dried spent ion exchange resin of step (A).

In step (B), the radionuclide-containing ion exchange group is separated from the spent ion exchange resin, and thus may be converted into a compound derived from the radionuclide-containing ion exchange group, and in this case, the compound derived from the radionuclide-containing ion exchange group may be at least one of a radionuclide-containing sulfide and a radionuclide-containing sulfur oxide.

In step (B), from the radionuclide-containing ion exchange group separated from the spent ion exchange resin, at least one of a radionuclide-containing sulfide and a radionuclide-containing sulfur oxide may be produced via at least one of a radionuclide-containing oxide and a radionuclide-containing hydroxide.

The separation of the radionuclide-containing ion exchange group is for separating a radionuclide from the spent ion exchange resin, and the radionuclide-containing ion exchange group may further contain sulfur atoms, and specifically may be SO₃M⁺ which is a functional group including a radionuclide cation (M⁺).

The separation of the ion exchange group in step (B) may be performed within a temperature range of 150° C. to 400° C. When the temperature for performing the separation of the ion exchange group in step (B) is less than 150° C., a problem in that the ion exchange group is not properly separated from the spent ion exchange resin may also occur, and when the temperature for performing the separation of the ion exchange group in step (B) is more than 400° C., the residence time in the graphite reactor is shortened due to the fast generation rate of sulfur dioxide gas (SO₂), so that a problem in that an unreacted radionuclide and SO₂ gas may also be generated may occur because the sulfur dioxide gas (SO₂) and the radionuclide are not smoothly brought into contact with each other.

Meanwhile, it is characterized in that sulfur dioxide gas (SO₂) generated in step (B) may react with the radionuclide component included in the radionuclide-containing oxide or the radionuclide-containing hydroxide to be converted into a radionuclide-containing sulfide or a radionuclide-containing sulfur oxide while being allowed to remain sufficiently in the graphite reactor. When sulfur dioxide gas (SO₂) is present even in a trace amount in the reactor, a radionuclide-containing oxide or a radionuclide-containing hydroxide may be converted into a radionuclide-containing sulfide or a radionuclide-containing sulfur oxide, so that the radionuclide-containing oxide or the radionuclide-containing hydroxide may also be converted into a non-volatile compound derived from a radionuclide-containing ion exchange group (a radionuclide-containing sulfide or a radionuclide-containing sulfur dioxide) by allowing the sulfur dioxide gas (SO₂) generated in step (B) to remain without being discharged into the outside.

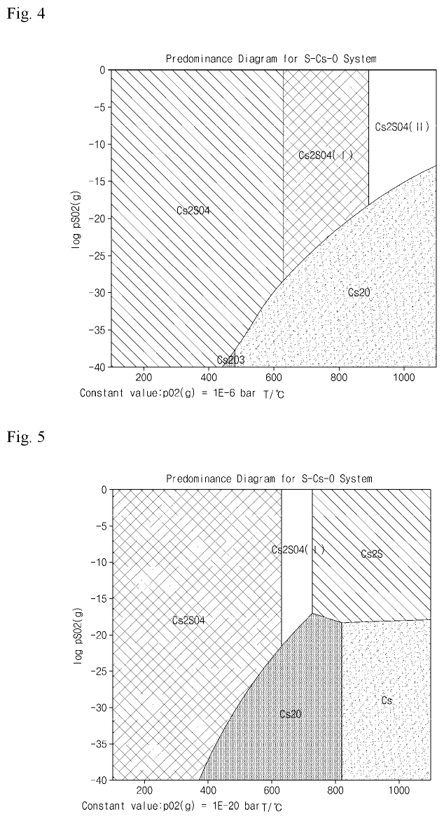

As an example for that, the forms of compound which may be formed depending on the temperature and oxygen partial pressure in an S—Cs—O system are illustrated in FIGS. 4 and 5. This indicates that Cs₂SO₄ among oxides including the radionuclide is a form of a compound in an atmosphere where sulfur dioxide gas (SO₂) is present, and as illustrated in FIGS. 4 and 5, it can be seen that even though oxygen is present at a concentration of 1 ppm (1E⁻⁶ bar), radioactive cesium (Cs) may be converted into Cs₂SO₄ which is a non-volatile sulfur oxide form, when the sulfur dioxide gas (SO₂) is present in a gas phase regardless of the partial pressure of sulfur dioxide gas (SO₂).

In addition, in step (B), an organic component in the spent ion exchange resin from which the radionuclide-containing ion exchange group is separated is not decomposed, and only a small volume of sulfur dioxide gas (SO₂), which has not reacted with a radionuclide component, a radionuclide-containing oxide, or a radionuclide-containing hydroxide, is discharged, so that unlike the incineration or vitrification process of the spent ion exchange resin in the related art, a large volume of an exhaust gas including SO₂ and SO₃ is not generated, so that there is an advantage in that the process is simplified because there is no need for an apparatus for treating a large volume of an exhaust gas.

After the radionuclide-containing ion exchange group is separated from the spent ion exchange resin through step (B), an exhaust gas including a spent ion exchange resin from which an ion exchange group is separated, a radionuclide-containing oxide or radionuclide-containing hydroxide, and sulfur dioxide gas (SO₂) may be generated.

Specifically, the spent ion exchange resin may include a styrene divinylbenzene polymer, a sulfonic acid group (SO₃H⁺) and a functional group (SO₃M⁺) including a radionuclide cation (M⁺), and in this case, the ion exchange group may be a sulfonic acid group (SO₃H⁺) or SO₃M⁺ which is a functional group including a radionuclide cation (M+), and after a radionuclide-containing ion exchange group is separated from the spent ion exchange resin through step (B), an exhaust gas including a styrene divinylbenzene copolymer, an oxide or hydroxide including a radionuclide, and sulfur dioxide gas (SO₂) may be present in the graphite reactor.

In this case, the step of producing a compound derived from a radionuclide-containing ion exchange group in step (B) may be performed within a temperature range of 400° C. to 550° C. When the temperature for performing the conversion into the compound derived from the radionuclide-containing ion exchange group in step (B) is less than 400° C., the conversion into the compound derived from the radionuclide-containing ion exchange group is slow, so that a problem in that the radionuclide may not be completely converted into a radionuclide-containing sulfide or a radionuclide-containing sulfur oxide may occur. In addition, when the temperature for performing the conversion into the compound derived from the radionuclide-containing ion exchange group in step (B) is more than 550° C., a problem in that the radionuclide may be gasified and discharged before being converted into the compound derived from the radionuclide-containing ion exchange group may occur. For example, when the temperature is more than 550° C., cesium (Cs) is gasified in the form of Cs₂O, CsOH, Cs₂O₂H₂, and the like, so that a problem in that the gasified product is discharged before being converted into a radionuclide-containing sulfide or sulfur oxide may occur.

When the compound derived from the radionuclide-containing ion exchange group is produced in step (B), step (B) may further include a step of injecting an inert gas into the graphite reactor in order to prevent a side reaction.

In this case, a radionuclide component in the radionuclide-containing ion exchange group (or the radionuclide-containing oxide or hydroxide) may be at least one selected from the group consisting of Cs, Sr, Mn, Fe, Ba, Ni, and Co, and the radionuclide-containing sulfur oxide may be at least one selected from the group consisting of Cs₂SO₄, SrSO₄, BaSO₄, NiSO₄, FeSO₄, MnSO₄, and CoSO₄. In this case, the radionuclide-containing sulfide or sulfur oxide is non-volatile, and does not gasify a radionuclide at a temperature of 700° C. or less.

The method for treating a spent ion exchange resin may further include a step of thermally decomposing the organic gas generated in step (B).

In particular, the organic component in the spent ion exchange resin in step (B) may be thermally decomposed, and as a result, an exhaust gas may be generated, and in this case, examples of the exhaust gas to be generated include benzene, toluene, ethylbenzene, styrene, and the like which are organic gases, along with sulfur dioxide gas (SO₂).

For the treatment of the exhaust gas, the organic gas may be completely combusted by a post-combustion apparatus and decomposed into CO₂ or H₂O, and for this purpose, oxygen or the air may be additionally injected into the post-combustion apparatus, and a gas including SO₂ discharged from the post-combustion apparatus may be completely cleaned and collected through a cleaning apparatus.

Step (C) is a step of carbonizing a residual organic material generated from the spent ion exchange resin from which the radionuclide-containing ion exchange group is separated into a carbide.

In this case, step (C) may further include a step of injecting an inert gas into the graphite reactor when a carbon component in the residual organic material is carbonized. Specifically, a compound derived from the radionuclide-containing ion exchange group is produced according to step (B), and through step (C), oxygen, hydrogen, and nitrogen components included in the residual organic material remaining in the spent ion exchange resin from which the ion exchange group is separated may be gasified to be cleaned and collected by a cleaning apparatus, and to convert (carbonize) the remaining carbon component into a carbide.

That is, it is possible to further include a step of injecting an inert gas in at least one step selected from steps (A) to (C), and the inert gas may be argon or nitrogen.

In this case, the step of carbonizing the spent ion exchange resin in step (C) may be performed within a temperature range of 550° C. to 700° C.

In particular, the components to be vaporized (oxygen, hydrogen, and nitrogen components) through step (C) do not include a radionuclide component or sulfur dioxide gas (SO₂), so that there is an advantage in that it is possible to exclude a problem in that a radionuclide component is deposited in an exhaust gas process, a problem in that a radionuclide component is discharged into the atmosphere along with an exhaust gas, and a problem in that an exhaust gas including sulfur dioxide gas (SO₂) is generated, which occur in the related art.

Step (D) is a step of separating the compound derived from the radionuclide-containing ion exchange group by converting the compound into a radionuclide-containing halide and gasifying (volatilizing, evaporating) the radionuclide-containing halide. In this case, the conversion and separation into the radionuclide-containing halide may be performed within a temperature range of 800° C. to 3,000° C.

When the temperature for performing the conversion into the radionuclide-containing halide in step (D) is less than 800° C., a problem in that the rate of conversion into the radionuclide-containing halide is slowed down may occur.

In step (D), it is possible to inject at least one of a halogen-containing gas and a halogenation compound gas.

The compound derived from the radionuclide-containing ion exchange group is a stable material at high temperature, but when a halogen-containing gas or a halogenation compound gas is present, the compound may react with a halogen to be converted into a halide.

The halogen-containing gas is at least one selected from F₂, Cl₂, Br₂, HCl, and HF, and the halogenation compound gas may be at least one selected from NF₃, CFCs, SF₆, and CCl₄. In this case, the at least one selected from NF₃, CFCs, SF₆, and CCl₄ may be decomposed at high temperature to generate a chlorine gas (Cl₂) or a fluorine gas (F₂).

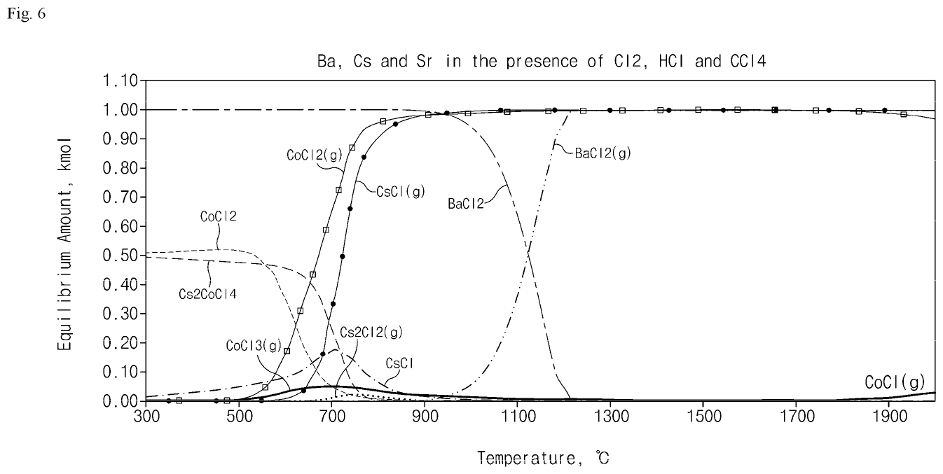

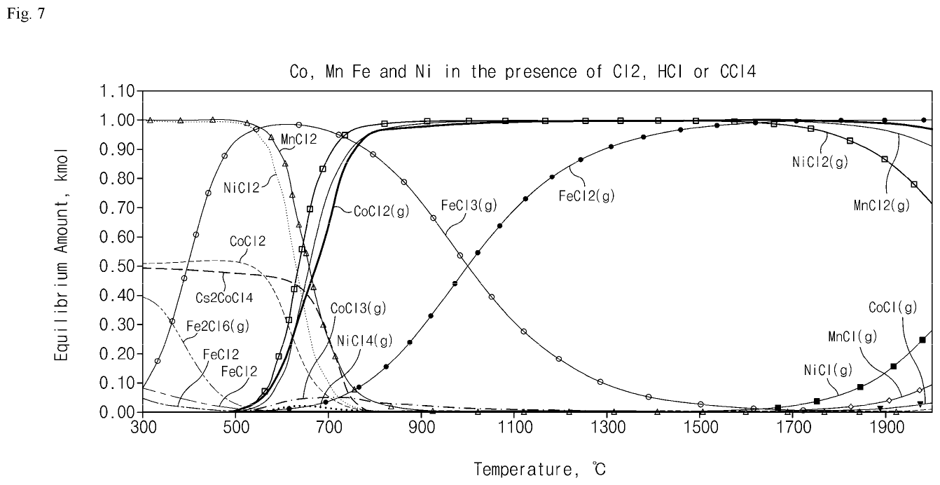

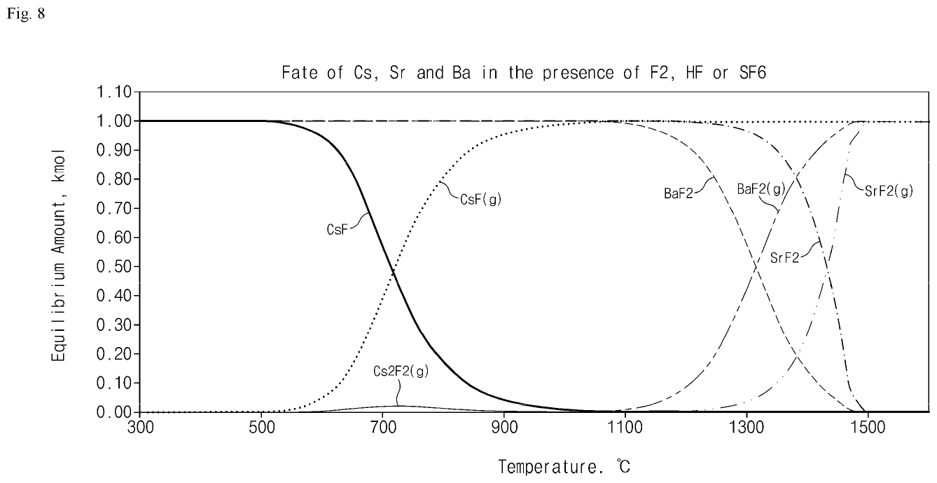

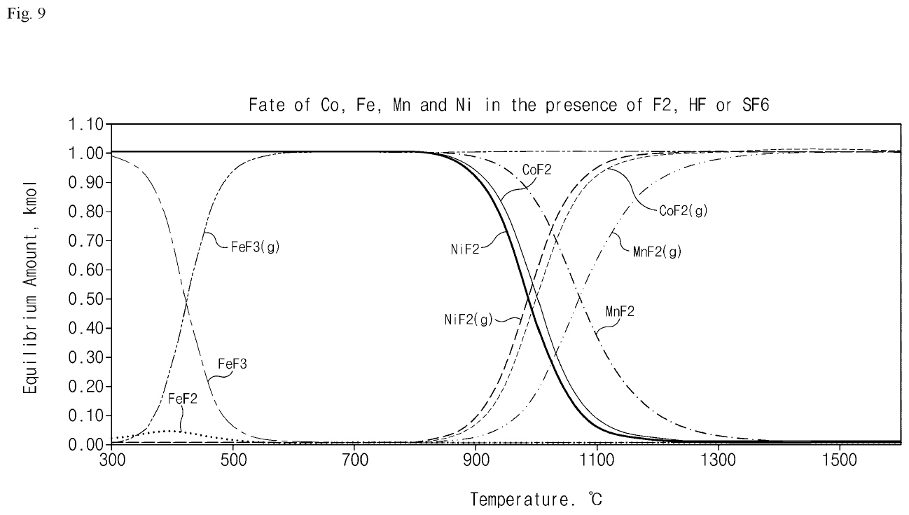

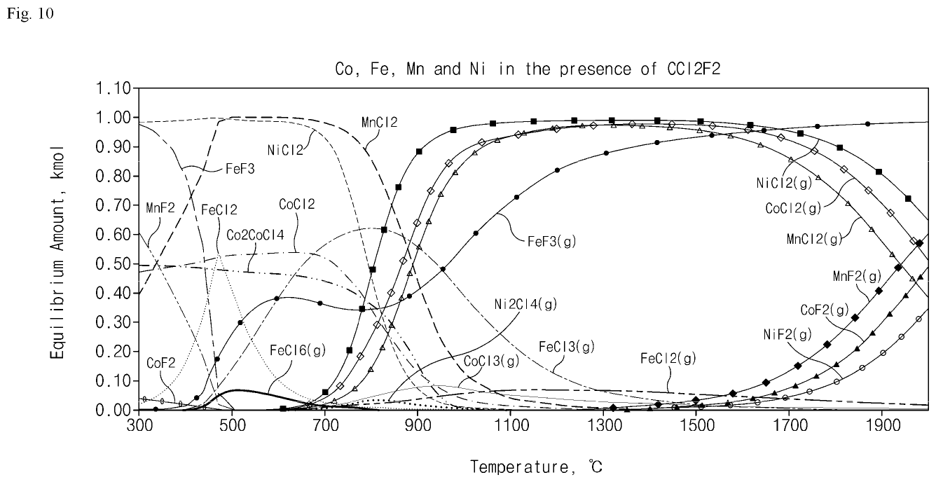

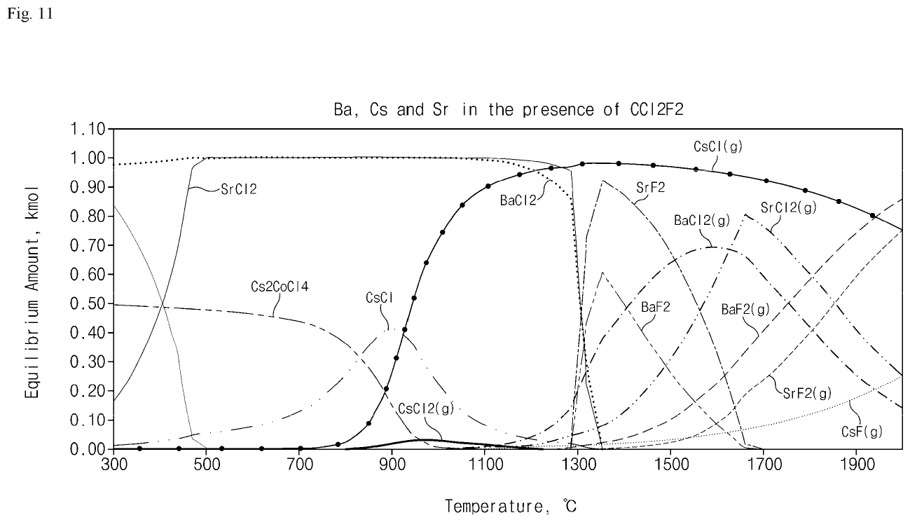

FIGS. 6 to 11 are graphs illustrating that trace amounts of Cs₂SO₄, SrFO₄, BaSO₄, CoSO₄, FeSO₄, NiSO₄, MnSO₄, and BaSO₄ in the carbonized spent ion exchange resin residue are mixed with one another at 1 ppm, and types of compounds which may be formed when the trace materials and 100 ppm of Cl₂ (g), Fe₂ (g), or a gas such as CC₄, NF₄, CFCs, or SF₆ which is a material generating Cl₂ (g) or Fe₂ (g) at high temperature are mixed with nitrogen and the resulting mixture is put into a reactor at high temperature, indicating that the compound is halogenated (chlorinated or fluorinated) at a predetermined temperature or more.

In FIGS. 6 to 11, it can be seen that trace amounts of Cs₂SO₄, SrSO₄, BaSO₄, CoSO₄, FeSO₄, NiSO₄, MnSO₄, and BaSO₄ in the carbonized spent ion exchange resin residue are mixed with one another at 1 ppm, and when the trace materials and 100 ppm of Cl₂ (g), Fe₂ (g), or a gas such as CC₄, NF₄, CFCs, or SF₆ which is a material generating Cl₂ (g) or Fe₂ (g) at high temperature are mixed with nitrogen and the resulting mixture is put into a reactor at high temperature, Ba, Cs, Sr, Co, Mn, Fe, or Ni, which is a radionuclide present in the form of a sulfide in a carbonized spent ion exchange resin, is separated into a chloride or fluoride which is highly volatile at high temperature, at a temperature of about 500° C. or more.

Meanwhile, the carbon component in the spent ion exchange resin in step (D) is not halogenated or gasified by a halogen-containing gas or a halogenation compound gas. Accordingly, in spite of a heat treatment at a high temperature of 2,000° C. or more in step (D), the carbon component may be present in the form of a carbide without being volatilized.

Step (D) may be a step of converting the compound derived from the radionuclide-containing ion exchange group into a radionuclide-containing halide by supplying a halogen-containing gas or a halogenation compound gas diluted with nitrogen or argon under a condition of 800° C. to 1,400° C.

The method for treating a spent ion exchange resin of the present invention may further include a step (E) of vacuum-evaporating the radionuclide-containing halide of step (D).

Step (E) may be a step of stopping the supply of the halogen-containing gas or the halogenation compound gas in step (D) and vacuum-evaporating and gasifying the radionuclide-containing halide within a temperature range of 1,400° C. to 3,000° C. under a reduced pressure condition of about 1 Torr or less.

When the temperature under the reduced pressure condition in step (E) is less than 1,400° C., the radionuclide-containing halide is not volatilized quickly, so that a problem in that the treatment time is prolonged may occur, and when the temperature is more than 3,000° C., a problem in that the consumption of unnecessary energy is generated may occur, and there is also a concern that the gasification of graphite may occur.

In addition, the method for treating a spent ion exchange resin of the present invention may further include a step (F) of condensing the radionuclide-containing halide of step (D).

Step (F) is a step of condensing and separating a halide including a radionuclide from an exhaust gas including a gasified (volatilized or evaporated) radionuclide-containing halide.

Through step (F), a trace amount of the radionuclide-containing halide condensed and recovered may also be fixed, and it is possible to obtain a maximum reduction effect during the process of separating/collecting/recovering the radionuclide from the spent ion exchange resin including the radionuclide-containing ion exchange group by separating a carbon component which is a main component in the spent ion exchange resin into a carbide to grant a regulatory exemption, and simultaneously to eco-friendly and efficiently decontaminate the spent ion exchange resin including the radionuclide-containing ion exchange group by reducing the generation of carbon dioxide (CO₂) to a minimum level.

According to the apparatus and method for treating a spent ion exchange resin as described above, unlike a process performed in each apparatus (reactor) by separating each step, it is possible to integrate an apparatus for treating an exhaust gas which should be installed for each reactor into one apparatus by performing a process of drying and carbonizing a spent ion exchange resin including the radionuclide-containing ion exchange group and halogenating a compound derived from the radionuclide-containing ion exchange group in one graphite reactor, it is possible to reduce the radiation exposure of workers by eliminating the separated process as described above, and it is possible to simplify the configuration of the apparatus and obtain an effect of cutting installation costs and operation costs of the process.

Furthermore, as a reactor, a heater, an insulating material, and tubes are provided with a graphite material, it is possible to prevent the corrosion of the treatment apparatus from a gas (particularly, a halogen gas) generated during the process of performing the drying of a spent ion exchange resin, the separation of a radionuclide-containing ion exchange group, the carbonization of the spent ion exchange resin, and the halogenation of a compound derived from the radionuclide-containing ion exchange group, so that the durability is excellent.

By the method for treating a spent ion exchange resin including a radionuclide according to the present invention, only the radionuclide may be volatilized and separated/recovered from the spent ion exchange resin without gasifying carbon which is a main component of the spent ion exchange resin, as the spent ion exchange resin including a radionuclide-containing ion exchange group is dried and carbonized in one same graphite reactor and the halogenation of a compound derived from the radionuclide-containing ion exchange group proceeds, and accordingly, a separate apparatus for treating exhaust gas need not be installed in each apparatus, so that there is an effect of reducing the radiation exposure of workers during the process of transporting the spent ion exchange resin from which radionuclides are not removed while simplifying the configuration of the apparatus and cutting installation costs and operation costs of a treatment process. Furthermore, it is possible to prevent a problem of generation of an exhaust gas including SO₂ and a problem of generation of a global warming gas CO₂ throughout the process of treating a spent ion exchange resin.

In addition, in a treatment apparatus used in the method for treating a spent ion exchange resin including a radionuclide-containing ion exchange group, it is possible to prevent corrosion and a reduction in durability occurring from the reaction of a gas generated during the heating of the spent ion exchange resin with an apparatus, and the like as all of a reactor, a heater, an insulating material, and tubes through which gases move are formed of a graphite material, and the reaction may be performed stably even at a high temperature of 2,000° C. or more by using the graphite reactor, so that there is an advantage in that only the radionuclide may be volatilized and separated/recovered from the spent ion exchange resin by drying and carbonizing the spent ion exchange resin including a radionuclide-containing ion exchange group and performing the halogenation of a compound derived from the radionuclide-containing ion exchange group in one reactor as described above.

Hereinafter, the present invention will be described in more detail by way of examples. However, these examples are provided only to promote understanding of the present invention, and the scope of the present invention is not limited to these examples in any sense.

### EXAMPLES

### Examples 1, 2 and Comparative Example 1

Cobalt and Cesium-containing spent ion exchange resin (prepared by stirring strongly acidic cation exchange resin (AMBERLITE IRN77) in a solution of high purity CoCl₂ and CsCl in water for this experiment) was placed in a graphite reactor of 5 kg/batch capacity in a graphite furnace and heated to the conditions shown in Table 1.

TABLE 1

| | heating condition of graphite reactor | | |
|---|---|---|---|
| | heating temperature | heating rate | gas atmosphere |
| Example 1 | room | 20 K/min | N2 (>99.999%) |
| | temperature~1000° C. | | |
| | 1000° C.~1500° C. | 10 K/min | Cl2 2000 ppm/N2 |
| Example 2 | room | 20 K/min | N2 (>99.999%) |
| | temperature~1000° C. | | |
| | 1000° C.~1500° C. | 10 K/min | Cl2 2000 ppm/N2 |
| | 1500° C.~1600° C. | 10 K/min | N2 (>99.999%) |
| Comparative | room | 20 K/min | N2 (>99.999%) |
| example 1 | temperature~1500° C. | | |
| | holding for 30 minutes | — | |
| | at 1500° C. | | |

### Experimental Example 1

The results of calculating the Mass Reduction Factor (MRF) for the spent ion exchange resins treated in Examples 1 and 2 and Comparative example 1 are shown in Table 2 below.

Co and Cs analysis results of ICP-AES (Inductively Coupled Plasma-Atomic Emission Spectroscopy) in the spent ion exchange resins treated in Examples 1 and 2 and Comparative example 1 are shown in Table 3 below, and the decontamination factor (DF) (=The ratio of the total weight of the target nuclide in the initial (pre-treatment) spent ion exchange resin to the total weight of the target nuclide in the spent ion exchange resin after treatment) of Co and Cs was determined using the results of Table 2. (For example, the decontamination factor (DF) for Co of Example 1 is 2 kg×1.6E-03/0.712 kg×5.2E-04=8.6E+00)

TABLE 2

| | mass (kg) | | |
|---|---|---|---|
| | initial spent ion | spent ion exchange | Mass Reduction |
| | exchange resin | resin after treatment | Factor (MRF) |
| Example 1 | 2 | 0.712 | 2.8E+00 |
| Example 2 | 4 | 1.264 | 3.2E+00 |
| Comparative | 1 | 0.341 | 2.9E+00 |
| example 1 | | | |

TABLE 3

| | elemental analysis (g/g) | | | | | |
|---|---|---|---|---|---|---|
| | initial spent ion | | spent ion exchange | | Decontamination | |
| | exchange resin | | resin after treatment | | Factor (DF) | |
| | Co | Cs | Co | Cs | Co | Cs |
| Example 1 | 1.6E−03 | 5.1E−04 | 5.2E−04 | 5.1E−06 | 8.6E+00 | 2.8E+02 |
| Example 2 | | | 5.5E−04 | 4.5E−06 | 9.2E+00 | 3.6E+02 |
| Comparative | | | 4.5E−03 | 6.5E−04 | 1.1E+00 | 2.3E+00 |
| example 1 | | | | | | |

According to Table 2, the mass of the spent ion exchange resin was reduced to about 30 to 35% compared to the initial (before treatment) mass of the spent ion exchange resin regardless of the supply of chlorine gas. Thus, the mass reduction factor is found to be approximately 3 because almost all of the oxygen, nitrogen, hydrogen and sulfur components were removed during the carbonization.

In addition, according to Table 3, in Comparative example 1 it can be confirmed that the decontamination factor of Co and Cs is 1.1 and 2.3, respectively, almost no decontamination effect. This means that not only Co but also semi-volatile components, Cs, were converted into sulfides or sulfur oxides such as CoS, CoSO₄, Cs₂S and Cs₂SO₄, which are stable at high temperatures during the carbonization.

On the other hand, in Examples 1 and 2, which were supplied with a mixture of Cl₂ gas at a high temperature after carbonization of the spent ion exchange resin, the Cs component was almost completely removed, and the decontamination factor was over 100. In case of Co, the decontamination factor of about 9 was shown, confirming the decontamination effect of about 90%.

Particularly in Examples 1 and 2, although the operating temperature was relatively low and the supply concentration of chlorine gas was relatively low, the decontamination factor of about 9 was shown for the nonvolatile nuclide Co. It will be shown that decontamination effects are sufficient when higher chlorine gas (halogen containing gas) or other halogenated gas concentrations.

What is claimed is:

1. An apparatus for treating a spent ion exchange resin, the apparatus comprising: a graphite reactor for receiving a spent ion exchange resin comprising a radionuclide-containing ion exchange group therein;
a graphite heater for heating the spent ion exchange resin;
an inert gas injection tube for injecting an inert gas into the graphite reactor for drying and carbonizing the spent ion exchange resin; and
a halogenation gas injection tube for injecting a halogen-containing gas or a halogenation compound gas into the graphite reactor for halogenation of a compound derived from the radionuclide-containing ion exchange group.

2. The apparatus of claim 1, wherein the graphite reactor is for stepwisely performing the drying of the spent ion exchange resin, the separation of the radionuclide-containing ion exchange group, the carbonization of the spent ion exchange resin, and the halogenation of the compound derived from the radionuclide-containing ion exchange group.

3. The apparatus of claim 1, wherein the apparatus comprises a porous dispersion plate in each of an upper part and a lower part in the graphite reactor.

4. The apparatus of claim 1, wherein the graphite heater is disposed outside the graphite reactor, and
the graphite heater further comprises a graphite insulating material surrounding the graphite heater.

5. The apparatus of claim 2, further comprising a temperature adjusting member for adjusting the temperature inside the graphite reactor in accordance with the drying of the spent ion exchange resin, the separation of the radionuclide-containing ion exchange group, the carbonization of the spent ion exchange resin, and the halogenation of the compound derived from the radionuclide-containing ion exchange group.

6. The apparatus of claim 1, wherein the radionuclide-containing ion exchange group further contains sulfur atoms,
the radionuclide-containing ion exchange group is separated from the spent ion exchange resin, and thus is converted into a compound derived from the radionuclide-containing ion exchange group, and
the compound derived from the radionuclide-containing ion exchange group is at least one of a radionuclide-containing sulfide and a radionuclide-containing sulfur oxide.

7. The apparatus of claim 6, wherein the radionuclide-containing ion exchange group is separated from the spent ion exchange resin, and as a result, at least one of a radionuclide-containing sulfide and radionuclide-containing sulfur oxide is produced via at least one of a radionuclide-containing oxide and a radionuclide-containing hydroxide.

8. The apparatus of claim 1, further comprising a cleaning apparatus for cleaning a volatile radionuclide gas, water vapor, or an acidic gas generated by heating the spent ion exchange resin.

9. The apparatus of claim 1, further comprising a post-combustion apparatus for thermally decomposing and removing the organic gas generated by heating the spent ion exchange resin.

10. A method for treating a spent ion exchange resin, the method comprising steps of:
(A) drying a spent ion exchange resin comprising a radionuclide-containing ion exchange group;
(B) producing a compound derived from the radionuclide-containing ion exchange group by separating the radionuclide-containing ion exchange group from the dried spent ion exchange resin;
(C) carbonizing the spent ion exchange resin from which the radionuclide-containing ion exchange group is separated; and
(D) converting a compound derived from the radionuclide-containing ion exchange group into a radionuclide-containing halide,
wherein steps (A) to (D) are performed in the same graphite reactor.

11. The method of claim 10, wherein step (D) is converting the compound derived from the radionuclide-containing ion exchange group into the radionuclide-containing halide by supplying a halogen-containing gas or a halogenation compound gas diluted with nitrogen or argon under a condition of 800° C. to 1,400° C.

12. The method of claim 10, further comprising a step (E) of vacuum-evaporating the radionuclide-containing halide of step (D).

13. The method of claim 10, further comprising a step (F) of condensing the radionuclide-containing halide of step (D).

14. The method of claim 10, wherein the radionuclide-containing ion exchange group further contains sulfur atoms,
the radionuclide-containing ion exchange group is separated from the spent ion exchange resin, and thus is converted into a compound derived from the radionuclide-containing ion exchange group in step (B), and
the compound derived from the radionuclide-containing ion exchange group is at least one of a radionuclide-containing sulfide and a radionuclide-containing sulfur oxide

15. The method of claim 14, where in step (B), the radionuclide-containing ion exchange group is separated from the spent ion exchange resin, and as a result, at least one of a radionuclide-containing sulfide and radionuclide-containing sulfur oxide is produced via at least one of a radionuclide-containing oxide and a radionuclide-containing hydroxide.

16. The method of claim 10, wherein steps (A) to (D) are performed as a fixed bed reaction or a fluidized bed reaction in the graphite reactor.

17. The method of claim 10, wherein at least one step selected from steps (A) to (C) further comprises a step of injecting an inert gas.

18. The method of claim 10, further comprising a step of injecting at least one of a halogen-containing gas and a halogenation compound gas in step (D),
wherein the halogen-containing gas is at least one selected from F₂, Cl₂, Br₂, HCl, and HF, and the halogenation compound gas is at least one selected from NF₃, CFCs, SF₆, and CCl₄.

19. The method of claim 10, further comprising a step of cleaning and collecting a volatile radionuclide gas, water vapor, or an acidic gas, which is generated in step (A).

20. The method of claim 10, further comprising a step of thermally decomposing the organic gas generated in step (B).
